(19) United States
(12) Patent Application Publication
(10) Pub. No.: US 2025/0370252 A1
(43) Pub. Date: Dec. 4, 2025

(54) OBLIQUE ANGLE METAOPTICS

(71) Applicant: California Institute of Technology, Pasadena, CA (US)

(72) Inventors: Ian M. Foo, Pasadena, CA (US); Gregory D. Roberts, Pasadena, CA (US); Andrei Faraon, Pasadena, CA (US)

(21) Appl. No.: 19/215,983

(22) Filed: May 22, 2025

Related U.S. Application Data
(60) Provisional application No. 63/655,182, filed on Jun. 3, 2024.

(51) Int. Cl. G02B 27/00; G02B 1/00; G06F 30/23; G06F 111/10; H04N 23/52

(52) U.S. Cl. CPC G02B 27/0012; G02B 1/002; G06F 30/23; H04N 23/52; G06F 2111/10

(57) ABSTRACT

Methods and devices relating to volumetric meta-optic structures. A method involves computationally designing a three-dimensional refractive index profile using an adjoint-based optimization process. The process optimizes for sorting light based on wavelength or polarization at specific oblique incidence angles and accounts for source divergence using Gaussian beam simulations. A mode overlap figure of merit is employed, optionally including terms to minimize crosstalk. Fabrication constraints like material binarization and minimum feature size are handled via differentiable filters. Physical crosstalk barriers may optionally be modeled during optimization. The resulting optimized profile defines a manufacturable multi-layer structure comprising patterned dielectric materials configured to perform the target sorting function efficiently under the specified oblique angle conditions. An array of such devices, potentially comprising structurally distinct elements optimized for different angles, can be integrated with an image sensor.

### CROSS REFERENCE TO RELATED APPLICATIONS

The present application claims priority to and the benefit of co-pending U.S. provisional patent application Ser. No. 63/655,182 entitled “Oblique Angle Metaoptics for Visible Wavelength Splitting on Image Sensors”, filed on Jun. 3, 2024, the disclosure of which is incorporated herein by reference in its entirety.

### TECHNICAL FIELD

The present disclosure relates generally to optical elements and methods for designing and fabricating such elements. More specifically, it relates to computationally designed volumetric meta-optic structures for manipulating electromagnetic radiation, particularly for sorting light based on properties such as wavelength and polarization, and methods for their design and fabrication.

### BACKGROUND

The present disclosure relates generally to multifunctional optical elements and methods for their design and fabrication. More particularly, it relates to volumetric meta-optic structures, often comprising multiple layers with sub-wavelength features, designed using computational optimization techniques to perform optical functions such as sorting light based on wavelength and polarization, for applications including image sensors.

Designing optical components capable of manipulating light based on multiple properties (e.g., wavelength, polarization, angle of incidence) simultaneously presents challenges. Traditional optical systems may rely on cascading multiple discrete components, which can lead to increased size and complexity. Metasurfaces, or two-dimensional structured interfaces, offer a path towards miniaturization but can face limitations in efficiency and the complexity of achievable functions due to the limited degrees of freedom inherent in planar structures.

Volumetric meta-optics, which involve structuring the refractive index within a three-dimensional volume, offer additional degrees of freedom, potentially enabling efficient and multifunctional devices. Designing these complex 3D structures often requires inverse design methods where the structure is computationally optimized to achieve a desired optical response.

Adjoint-based optimization methods have emerged as a tool for such inverse design problems. Co-owned U.S. Pat. No. 11,239,276, incorporated herein by reference in its entirety, discusses forming multi-functional optical elements using structures with sub-wavelength features, potentially composed of materials like TiO2 and SiO2 in layered configurations. It describes iterative optimization approaches, potentially guided by gradient descent using sensitivity analysis derived from forward and adjoint simulations, to determine the refractive index distribution while conforming to fabrication constraints such as binarization.

Further, co-owned U.S. Pat. No. 12,216,290, incorporated herein by reference in its entirety, describes 3D scattering structures designed using an adjoint variable method to optimize a specified objective function, such as focusing efficiency based on frequency and polarization, into different target areas. The patent also discusses calculating the sensitivity of the target function with respect to a refraction index based on forward and adjoint fields and incorporating fabrication constraints, including binarization using sigmoidal filters and enforcing minimum feature sizes using dilated density methods.

Additionally, work presented by Foo et al. at CLEO, May 16, 2022, titled “Inverse Design of Oblique Angle Metaoptics for Visible Wavelength Splitting,” incorporated herein by reference in its entirety, explored the inverse design of meta-optics specifically for non-normal (oblique) angles of incidence, recognizing that practical implementations may require performance over a range of input angles.

While these approaches have advanced the field, challenges remain in practical implementation. For instance, when such devices are implemented as an array over image sensor pixels under focused light from a preceding lens or other imaging system, different elements receive light at different angles (oblique incidence at the periphery) and with a range of divergence angles depending on the lens's numerical aperture and the spatial position. Device performance can drop significantly with deviations in incident angle and divergence angle. Furthermore, optical crosstalk between adjacent elements, where light intended for one pixel scatters into neighbors, is a persistent problem, exacerbated when designing for oblique incidence. There remains a need for design methodologies that address these practical challenges.

### SUMMARY

The present disclosure provides methods to address the above-mentioned challenges by designing and fabricating volumetric meta-optic structures configured to sort electromagnetic radiation based on wavelength or polarization under oblique angles of incidence. A computational optimization process using adjoint-based methods is employed to determine an optimized three-dimensional refractive index profile within a defined design volume. The optimization incorporates Gaussian beam simulations to account for source divergence and uses a figure of merit based on mode overlap at target spatial locations. Fabrication constraints, including binarization and minimum feature sizes, are enforced using differentiable filters.

Optionally, physical crosstalk barriers may be modeled within the optimization process. The resulting optimized structure comprises a multi-layer arrangement of dielectric materials with sub-wavelength features and is configured to direct incident light into distinct output regions with high efficiency. Arrays of such structures, including variations optimized for different angles of incidence, may be integrated with image sensors for improved spectral or polarization sorting performance across a field of view.

According to a first aspect of the present disclosure, a method for designing a volumetric meta-optic structure for sorting electromagnetic radiation incident from a source having a predetermined divergence angle onto a target plane is disclosed, the method comprising: defining, using a processor, a three-dimensional design volume having an initial refractive index distribution; establishing, using the processor, a target functionality comprising directing different predetermined wavelength bands or polarization states of electromagnetic radiation incident on the design volume at a predetermined oblique angle of incidence relative to a normal of the design volume to distinct target spatial locations on the target plane; formulating, using the processor, a figure of merit function based at least in part on a mode overlap calculation between electromagnetic fields at the target spatial locations and desired mode profiles for the predetermined wavelength bands or polarization states; performing, using the processor, an adjoint-based optimization of the refractive index distribution within the three-dimensional design volume, wherein the optimization utilizes electromagnetic simulations employing a Gaussian beam profile corresponding to the predetermined divergence angle as the incident electromagnetic radiation at the predetermined oblique angle, the optimization iteratively updating the refractive index distribution to optimize the figure of merit function while adhering to one or more predetermined fabrication constraints applied via differentiable filters; and outputting, using the processor, the optimized refractive index distribution defining the physical structure of the volumetric meta-optic device.

According to a second aspect of the present disclosure, a method for fabricating a volumetric meta-optic structure configured for sorting electromagnetic radiation incident at a predetermined oblique angle is disclosed, the method comprising: obtaining an optimized three-dimensional refractive index profile defining a multi-layer arrangement of at least two dielectric materials in a non-periodic pattern having sub-wavelength features, wherein the optimized refractive index profile is determined by an adjoint-based optimization process utilizing electromagnetic simulations employing a Gaussian beam profile incident at the predetermined oblique angle; and fabricating the multi-layer, three-dimensional structure according to the optimized refractive index profile by sequentially forming a plurality of layers, wherein forming each layer comprises arranging the at least two dielectric materials according to the non-periodic pattern specified by the optimized refractive index profile for that layer.

According to a third aspect of the present disclosure, volumetric meta-optic device for sorting electromagnetic radiation incident at a predetermined oblique angle from a source having a predetermined divergence angle is provided, the device comprising: a multi-layer, three-dimensional structure comprising at least two dielectric materials arranged in a non-periodic pattern within a volume according to an optimized refractive index profile, the pattern having sub-wavelength features; wherein the optimized refractive index profile is determined by an adjoint-based optimization process utilizing electromagnetic simulations employing a Gaussian beam profile corresponding to the predetermined divergence angle incident at the predetermined oblique angle, and optimizing a figure of merit function based at least in part on a mode overlap calculation; and wherein the arrangement of the at least two dielectric materials within the multi-layer, three-dimensional structure is configured to cause multiple scattering of incident electromagnetic radiation to direct different predetermined wavelength bands or polarization states thereof to distinct target spatial locations on an output plane adjacent to the device.

### BRIEF DESCRIPTION OF THE FIGURES

FIG. 1 (panels (a) and (b)) shows device layout concepts and the challenge of varying incidence angles in an array.

FIG. 2 (panels (a) and (b)) shows schematic details of an inverse-designed device structure and example optimized layer patterns.

FIG. 3 (panels (a) through (c)) shows aspects of the binarization process used during optimization, such as the sigmoidal filter, gradient weights, and figure of merit (FoM) trace, respectively.

FIG. 4 (panels (a) through (e)) shows the incorporation and effect of various fabrication constraints on device structure, where the grayscale layer, binarized layer, border constraint, island removal, and performance comparison in the use of border constraint are shown, respectively.

FIG. 5 describes, via numbered steps S1-S12, a flowchart outlining the refined adjoint-based optimization methodology performed using a computer system.

FIG. 6 shows performance results for array implementation using explicit re-optimization for different angles.

### DEFINITIONS

For the purposes of this disclosure, the following terms are defined as follows.

The term “optimization” refers generally to a process of iteratively or systematically adjusting parameters or variables of a system, model, or design, potentially subject to certain constraints, to find a solution that improves or maximizes a defined objective function or figure of merit, or minimizes a cost function. This process may involve computational algorithms, including but not limited to gradient-based methods, to explore a design space and converge towards a solution exhibiting enhanced performance according to the objective function.

An “adjoint-based optimization” is a computational optimization technique that employs the adjoint method, often in conjunction with numerical simulations (like FDTD), to efficiently calculate the gradient (sensitivity) of an objective function (Figure of Merit) with respect to a large number of design parameters (such as the refractive index at many points in a volume). This gradient information is then used to iteratively update the design parameters towards an optimized solution.

A “volumetric meta-optic structure” is a three-dimensional structure, typically comprising multiple layers and engineered features, designed to manipulate electromagnetic radiation through scattering within its volume. The structure possesses a spatially varying refractive index profile, often with features comparable to or smaller than the wavelength of operation.

A “refractive index profile” is the spatial distribution of the refractive index, often denoted as n(x, y, z), within a defined volume or structure, which dictates how electromagnetic radiation propagates through and interacts with the structure.

“Sub-wavelength features” are structural elements or variations in material properties within a device having dimensions smaller than the wavelength of the electromagnetic radiation the device is designed to operate with.

“Mode overlap” is a measure quantifying the similarity or coupling efficiency between two electromagnetic field distributions (modes) over a defined surface or area, often calculated via an overlap integral involving the complex field vectors.

A “figure of merit” (FoM) is a quantitative measure or function used in an optimization process to evaluate the performance of a design or system with respect to one or more target objectives. The optimization process typically seeks to maximize or minimize the FoM value.

A “Gaussian beam profile” is a description of an electromagnetic beam whose transverse electric field and intensity distributions are approximated by Gaussian functions. It is characterized by parameters such as beam waist and divergence angle and is often used to model focused laser beams or outputs from optical fibers.

A “divergence angle” is a measure of the angular spread of an electromagnetic beam as it propagates toward or away from its narrowest point (beam waist), related to the beam's wavelength and waist size.

An “oblique angle of incidence” is the angle between the direction of propagation of incident electromagnetic radiation and the line perpendicular (normal) to the surface upon which it impinges, where this angle is greater than zero degrees.

“Crosstalk” is the unwanted transfer or leakage of electromagnetic energy from one intended path or spatial location to another adjacent or nearby location, potentially causing interference or degradation of performance. In the context of optical arrays, it refers to light intended for one element scattering into adjacent elements.

“Fabrication constraints” are limitations imposed on a design due to the capabilities and limitations of the manufacturing or fabrication processes intended to produce the physical device. Examples include restrictions on minimum feature size, allowable materials, layer thicknesses, or the requirement for binary material compositions (binarization).

A “differentiable filter” is a mathematical operation or function applied during computational optimization that modifies design parameters or gradients while maintaining differentiability with respect to the input parameters, allowing it to be incorporated within gradient-based optimization algorithms. Examples include filters used for smoothing, enforcing minimum feature sizes, or promoting binarization.

### DETAILED DESCRIPTION

The present disclosure provides methods for designing volumetric meta-optic structures and the resulting physical structures, addressing the needs for robust performance by detailing a refined adjoint-based optimization process. This process, typically executed on a computer system comprising one or more processors and memory, is suited for designing structures for applications like color and polarization sorting on image sensor pixels. The methodology yields tangible structures with enhanced performance under realistic operating conditions including predetermined oblique angles of incidence (e.g., up to 40° demonstrated) and finite numerical aperture sources (varying divergence angles), and incorporates strategies for active crosstalk mitigation through specific structural design features.

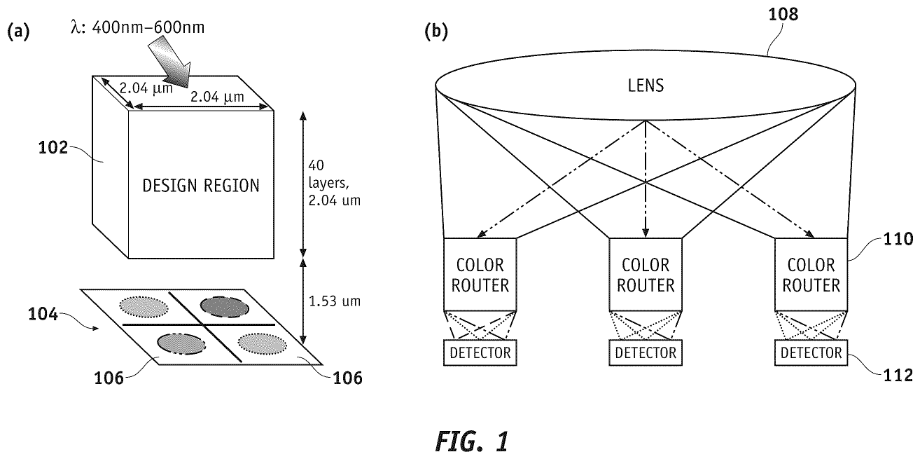

The device layout and the challenge of varying incidence angles in array applications are illustrated first in FIG. 1.

Panel (a) shows a schematic of a device layout, including a design region 102 defined within specific dimensions (e.g., 2.04 μm×2.04 μm laterally, 2.04 μm height comprised of 40 layers) situated above a focal plane 104 (e.g., at 1.53 μm distance) where sorted light components (e.g., different colors) are directed to target quadrants 106. Panel (b) highlights that in a typical imaging scenario with a lens 108 focusing light onto an array of such devices including color routers 110 and detectors 112. The angle at which light strikes each color router 110 varies with the position of the router relative to the lens axis. While central routers might receive normally incident light, peripheral routers receive light at oblique angles. This necessitates designing device structures that function effectively under these non-normal incidence conditions.

According to the teachings of the present disclosure, the design process involves computationally determining, using a computer system, an optimal three-dimensional refractive index distribution, n(x, y, z), within the design volume, which defines the physical structure of the device.

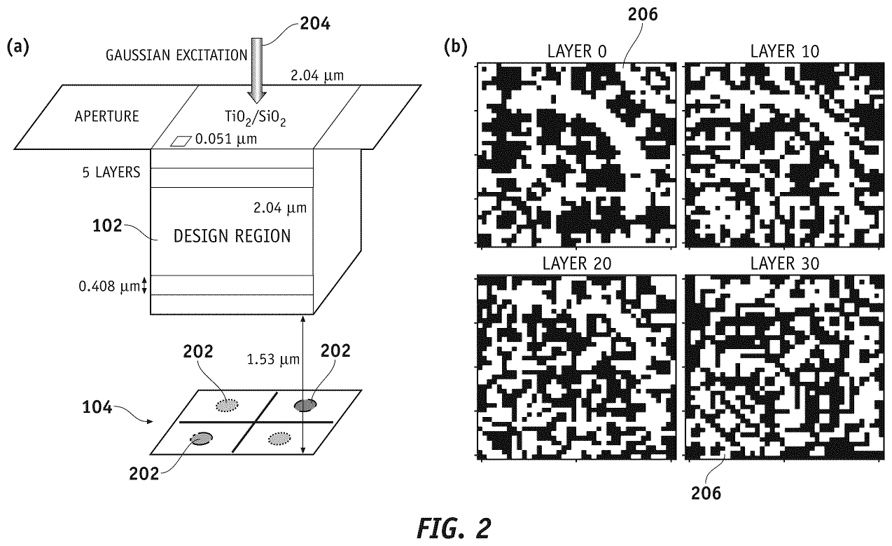

FIG. 2 provides further schematic detail pertinent to the optimization process. Panel (a) depicts the inverse-designed color router device structure, indicating incident excitation 204 and the projection of sorted light (e.g., R, G, B components) onto distinct focal spots 202 on the focal plane 104.

To better model realistic imaging systems where light is focused, the incident light 204 can be simulated not just as a plane wave, but as a finite Gaussian beam, as indicated in FIG. 2, panel (a). This approach accounts for the inherent spread of momentum vectors, or divergence angle, associated with focused light, which depends on the numerical aperture (NA) or f-number of the preceding lens (e.g., typical divergence angles of 13±5° for smartphone lenses, yielding a beam waist of ≈1.55 μm at the device surface). The methodology accommodates optimization for various divergence angles. The resulting internal structure, defined by the optimized refractive index profile (e.g., a specific 3D arrangement of TiO2 and SiO2 materials), causes multiple scattering which is precisely engineered via the optimization to achieve the desired sorting functionality. Panel (b) of FIG. 2 shows examples of optimized structural patterns for selected layers 206 (Layers 0, 10, 20, 30) of an exemplary 5-layer device. These patterns illustrate the complex, non-intuitive, yet structured (potentially symmetric) physical geometries resulting from the optimization, where binarization and bridging constraints have been imposed to ensure manufacturability. The final output of the design process is this optimized refractive index profile, typically stored in computer memory or storage, which serves as a blueprint for fabricating the physical device structure.

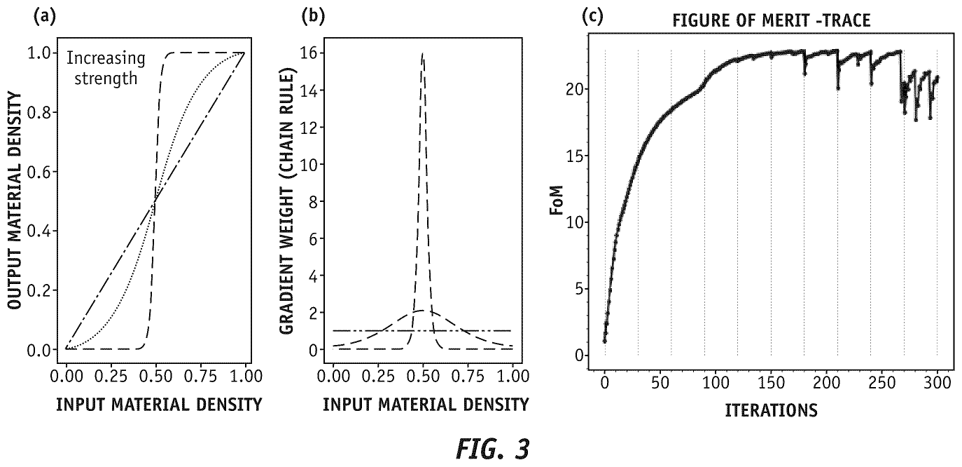

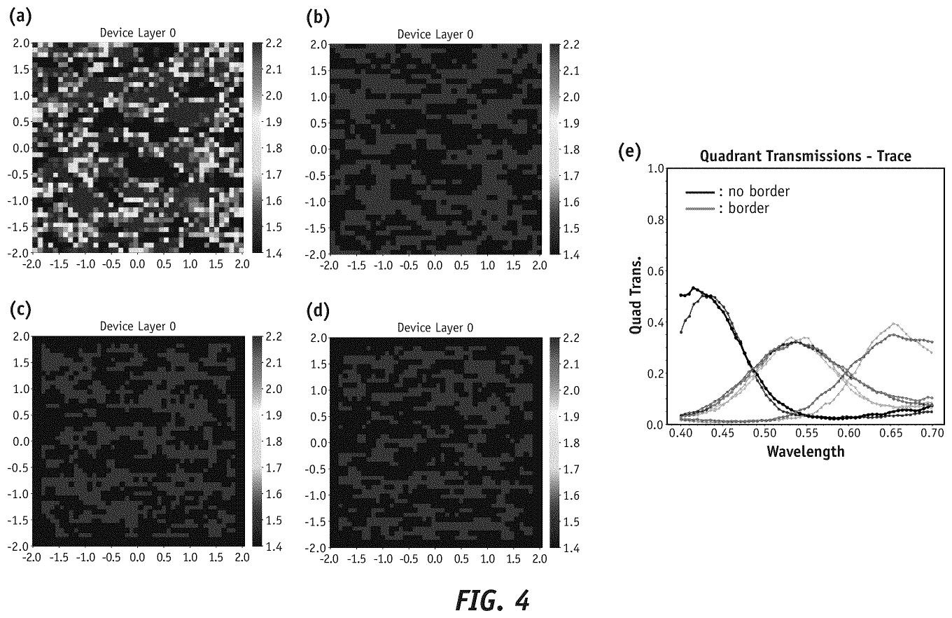

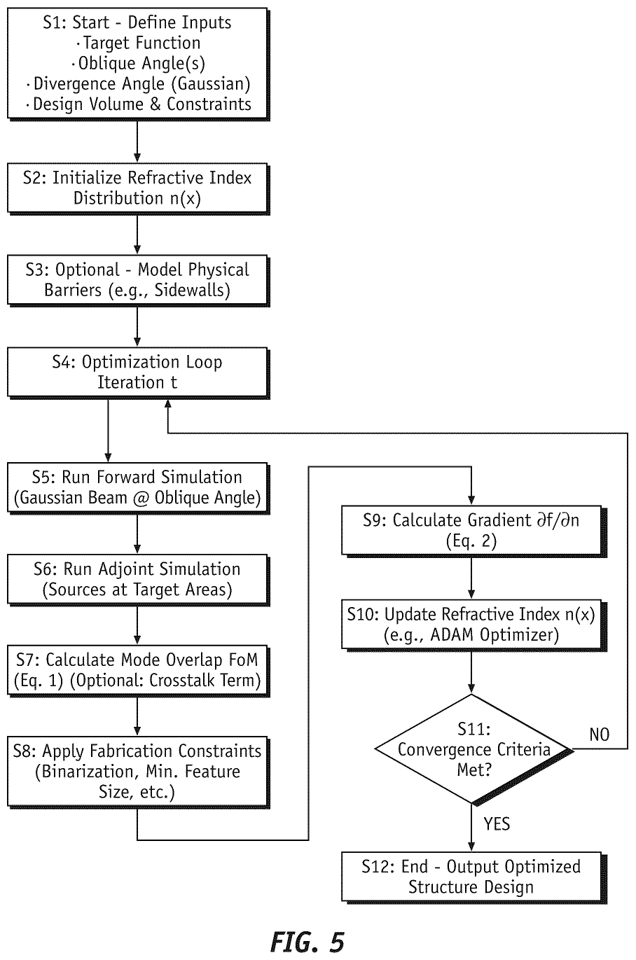

Before describing in detail FIG. 3 and FIG. 4, an overview of the refined optimization methodology, executed by a computer system, is presented conceptually in FIG. 5 via steps S1 through S12.

The process begins at Step S1 where the computer system defines or receives the inputs. These include the target optical function (e.g., sorting specific wavelengths/polarizations), the target oblique incidence angle(s) for which the device structure should be optimized, the divergence angle of the source (which dictates the parameters for Gaussian beam modeling), the design volume dimensions, and applicable fabrication constraints (such as material choices and minimum feature sizes).

Following input definition, the computer system initializes the refractive index distribution n(x) within the volume (Step S2), for example, to a uniform intermediate value between the available material indices.

Optionally, as part of the iterative loop (Step S3), physical barrier structures (sidewalls) can be explicitly modeled by the computer system within the simulation domain. The optimization accounts for these structures, for instance by setting the gradient sensitivity to zero within the barrier regions. This allows designing the active scattering volume structure to function correctly in the presence of such integrated crosstalk-reducing structural elements. Simulations incorporating air sidewall structures (e.g., 85 nm thick, 1.148 μm deep) demonstrated reduced side/oblique scattering and improved focal transmission.

The computer system then enters an iterative optimization loop, starting at Step S4 for iteration t. Within each iteration, the computer system performs steps incorporating specific refinements.

As mentioned, the forward electromagnetic simulation (Step S5) uses a finite Gaussian beam profile as the incident source, configured with the specified divergence angle and incident at the target oblique angle(s).

An adjoint electromagnetic simulation is then performed (Step S6), typically using sources placed at the target area(s) on the focal plane, derived from the results of the forward simulation. These electromagnetic simulations are computationally intensive and are typically performed using numerical methods like the Finite-Difference Time-Domain (FDTD) method executed on the computer system, potentially utilizing parallel processing or specialized hardware like Graphics Processing Units (GPUs) for acceleration.

Based on the fields calculated in the forward and adjoint simulations, the computer system evaluates a Figure of Merit (FoM) function (Step S7). A mode overlap FoM, comparing actual fields (E, H) with desired target mode fields (Eₘ, Hₘ) over a target surface area S (e.g., a focal plane quadrant), can be effective:

$$f ( n ( x ) ) = \frac{1}{8} \frac{{\vert {\int }_{s} ( E \times {H}_{m}^{*} \cdot dS + {\int }_{s} {E}_{m}^{*} \times H \cdot dS ) \vert}^{2}}{{\int }_{s} Re ( {E}_{m} \times {H}_{m}^{*} ) \cdot dS} \qquad ( 1 )$$

Here, E, H are the actual complex field vectors over the target surface S, Eₘ, Hₘ are the desired mode field profiles, * denotes the complex conjugate, x is the cross product, • is the dot product, and Re( ) is the real part.

The optimization algorithm implemented on the computer system seeks to maximize this FoM. Optionally, as part of Step S7, the FoM formulation can be adapted to minimize crosstalk by including terms that minimize the mode overlap or field intensity in regions of the focal plane corresponding to adjacent pixels. This directly influences the resulting structure to reduce scattering into unwanted areas.

In accordance with the embodiments of the present disclosure, fabrication constraints, which dictate aspects of the final physical structure, are handled by the computer system using differentiable filters applied to the gradient or the refractive index update (Step S8).

The computer system calculates the gradient (sensitivity) of the FoM with respect to the refractive index,

$$\frac{df}{dn ( x )} ,$$

efficiently using the adjoint method (Step S9):

$$\frac{df}{dn ( x )} = 2 n ( x ) Re \{ {E}_{fwd} \cdot {E}_{adj} \} \qquad ( 2 )$$

In Equation (2), n(x) represents the refractive index value at a specific point x within the design volume, Re{ } denotes taking the real part of the complex value within the braces, E_{fwd} is the complex electric field vector at point x resulting from the forward simulation (light propagating from source to target), and E_{adj} is the complex electric field vector at point x resulting from the adjoint simulation (light propagating effectively backward from the target). The dot product E_{fwd}·E_{adj} provides a measure of the interaction between the forward and adjoint fields at each point.

FIG. 3 illustrates aspects of handling binarization, the constraint that the structure should be composed of only two materials (e.g., TiO2 with n≈2.4 and SiO2 with n≈1.5). This is achieved using an intermediate density variable ρ (ranging 0-1) and a projection filter. Panel (a) of FIG. 3 shows a sigmoidal projection filter based on the hyperbolic tangent function:

$${ρ}_{proj} = \frac{tan h ( βη ) + tan h ( β ( ρ - η ) )}{tan h ( βη ) + tan h ( β ( 1 - η ) )} \qquad ( 3 )$$

Here, n is the binarization threshold (e.g., 0.5), and β controls the sharpness of the transition. Panel (a) shows the filter shape for weak (red line) versus strong (blue line) β. Panel (b) shows the corresponding gradient weights. Panel (c) shows an example FOM trace during optimization; the dips correspond to increases in the binarization strength β.

FIG. 4 further illustrates the incorporation and effect of fabrication constraints on the resulting structure. Panel (a) shows an example refractive index distribution for layer 0 early in optimization. Panel (b) shows the corresponding fully-binarized distribution after applying the projection filter (Eq. 3), resulting in a physical pattern composed primarily of two refractive index values. Panel (c) demonstrates enforcing a border constraint structure (e.g., 174 nm wide). Panel (d) illustrates the effect of applying morphological filters like erosion and dilation to modify the structure by removing small, isolated ‘islands’ of material. Panel (e) presents a performance comparison between (b) and (c) indicating that such structural constraints can often be implemented with minimal impact on the final device optical performance.

Based on the (potentially constrained and modified) gradient, the computer system updates the refractive index distribution n(x) (Step S10). The ADAM (Adaptive Moment Estimation) optimizer Eqs. (4a)-(4d), or similar algorithms, can be used for iterative updates:

$${m}_{t} = {β}_{1} {m}_{t - 1} + ( 1 - {β}_{1} ) \frac{df}{{dn}_{t}} \qquad ( 4 a )$$

$${v}_{t} = {β}_{2} {v}_{t - 1} + ( 1 - {β}_{2} ) {( \frac{df}{{dn}_{t}} )}^{2} \qquad ( 4 b )$$

$${α}_{t} = α + \frac{\sqrt{1 - {β}_{2}^{t}}}{1 + {β}_{1}^{t}} \qquad ( 4 c )$$

$${n}_{t + 1} = {n}_{t} + {α}_{t} \frac{{m}_{t}}{\sqrt{{v}_{t}} + ϵ} \qquad ( 4 d )$$

where mₜ, vₜ are moment estimates, β₁, β₂ are decay rates, a is the initial step size, and e is a small constant.

The computer system checks if convergence criteria are met (Step S11). If not, the loop repeats from Step S4.

If convergence is achieved, the final optimized refractive index profile, defining the volumetric meta-optic structure, is output (Step $12). This optimized profile represents the blueprint for the physical device.

The resulting internal structure, defined by this optimized profile, causes the multiple scattering needed for the sorting function. Panel (b) of FIG. 2 shows examples of the complex, non-intuitive, yet structured physical geometries in selected layers (Layers 0, 10, 20, 30) of an exemplary 5-layer device resulting from such an optimization.

Once the optimized refractive index profile is obtained (Step S12), it serves as a blueprint for manufacturing the physical volumetric meta-optic structure.

Fabrication of such multi-layer, three-dimensional structures defined by the optimized profile can be accomplished using various techniques of nanofabrication. One suitable approach is multi-layer lithography. In this process, the structure is built layer by layer. For each layer, a material deposition step (e.g., depositing a layer of a first dielectric material like TiO2) is followed by a patterning step (e.g., using photolithography or electron-beam lithography to define the features according to the optimized profile for that layer) and an etching step to remove unwanted material. Subsequently, a second dielectric material (e.g., SiO2) may be deposited to fill the gaps, followed by a planarization step (e.g., chemical-mechanical polishing) to create a flat surface for the next layer. This sequence is repeated for all layers defined in the optimized profile (as conceptually represented by the layers 206 in FIG. 2, panel (b)).

Another suitable approach is direct laser writing, such as two-photon polymerization (TPP). In TPP, a focused laser beam is scanned through a volume of photoresist material (e.g., a liquid polymer). At the laser focus, non-linear absorption initiates polymerization, hardening the resist locally. By precisely scanning the laser focus according to the three-dimensional pattern specified by the optimized refractive index profile, the desired structure can be written directly within the resist volume. Subsequent development steps remove the unpolymerized resist, leaving the fabricated structure. The choice of fabrication method may depend on factors such as the required resolution (sub-wavelength features), the number of layers, the chosen materials (e.g., TiO2/SiO2 or polymers), and desired throughput.

The computational steps described above, particularly the electromagnetic simulations (Steps S5, S6) and the iterative optimization updates (Steps S4-S10), are typically performed on a computer system. This system may comprise one or more processors (CPUs), potentially augmented with specialized hardware accelerators like GPUs, sufficient memory (RAM) to hold the simulation data and device representation, and non-volatile storage for the software and results. The methods can be implemented as software instructions stored on a non-transitory computer-readable medium, which, when executed by the processor(s), cause the computer system to perform the design methodology outlined in the steps S1-S12 described for FIG. 5. High-performance computing (HPC) clusters may be employed for large-scale simulations or optimizations.

The refined design methodology (conceptually outlined by steps S1-S12 for FIG. 5) and resulting physical structures described herein offer advantages for practical applications requiring sorting of light, particularly in array formats like image sensors.

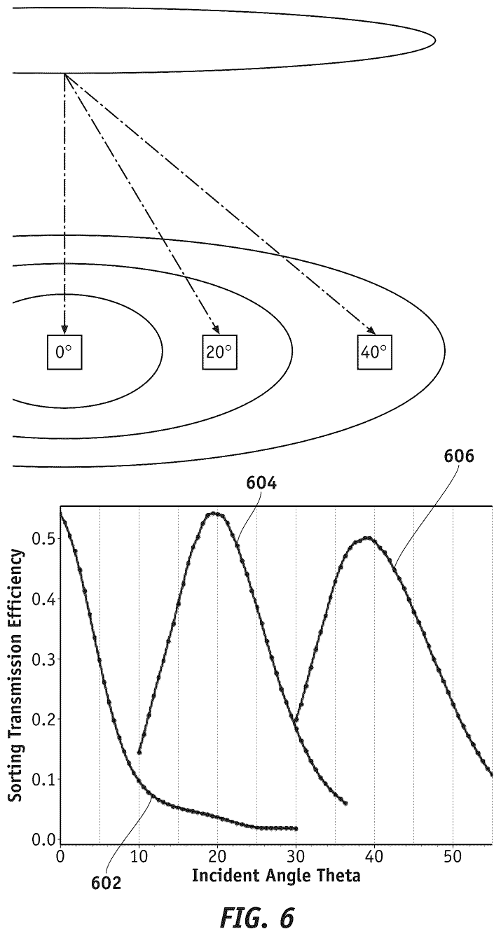

One result is the ability to design volumetric meta-optic structures that maintain high sorting efficiency (e.g., 60-80% peak efficiency demonstrated) even when specifically optimized for significantly oblique angles of incidence (e.g., up to) 40°, as shown by the performance curves (i.e. transmission efficiency) in FIG. 6. Performance curves 602, 604, 606 correspond to oblique angles of incidence 0°, 20°, 40° respectively. As can be noticed, the performance at oblique angles is comparable to that achieved by devices optimized for normal incidence.

The optimization process, incorporating the mode overlap FoM (Eq. 1) and Gaussian beam inputs (FIG. 5, Step S5), yields device structures that are robust not only to the central design angle but also exhibit a reasonable angular bandwidth (e.g., ±10° demonstrated). Furthermore, the method allows designing structures optimized for different divergence angles (included in input Step S1), ensuring adaptability to various imaging system parameters.

The integration of crosstalk mitigation strategies directly into the optimization (FIG. 5, Steps S7 and optionally S3) yields tangible structures with improved performance in array settings. By minimizing the FoM in adjacent pixel regions and/or explicitly modeling physical barrier structures during optimization, the resulting device structures exhibit reduced side and oblique scattering (e.g., reductions of 10% and 2.4% respectively demonstrated with air walls) and increased power confinement within the target pixel, leading to higher effective focal transmission (e.g., improved from ˜70% to 74% in simulations). These barriers form an integral part of the final device structure.

The strategy of utilizing different device structures, each optimized for a specific central angle (as shown in FIG. 6), allows for maintaining high and consistent sorting performance across an entire array (e.g., an image sensor surface) where the angle of incidence naturally varies, overcoming the inherent performance degradation of a single device structure over a wide angular range. This results in an array comprising multiple structurally distinct meta-optic elements.

The incorporation of differentiable filters for fabrication constraints (e.g., binarization via Eq. 4, minimum feature size, border constraints, island removal, illustrated in FIGS. 3 and 4 and included in Step S8 of FIG. 5) ensures that the optimized designs translate into manufacturable physical structures with defined features using standard fabrication techniques (like multi-layer lithography or two-photon polymerization) often with minimal penalty to the optical performance, as indicated in FIG. 4, panel (e).

Collectively, these features-high efficiency at oblique angles, adaptability to divergence angles, integrated structural crosstalk reduction yielding improved power confinement, array-wide performance consistency via structurally distinct re-optimized elements, and manufacturability of the complex structures-represent advances enabled by the disclosed design methodology and resulting structures.

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

1. A method for designing a volumetric meta-optic structure for sorting electromagnetic radiation incident from a source having a predetermined divergence angle onto a target plane, the method comprising:
defining, using a processor, a three-dimensional design volume having an initial refractive index distribution;
establishing, using the processor, a target functionality comprising directing different predetermined wavelength bands or polarization states of electromagnetic radiation incident on the design volume at a predetermined oblique angle of incidence relative to a normal of the design volume to distinct target spatial locations on the target plane;
formulating, using the processor, a figure of merit function based at least in part on a mode overlap calculation between electromagnetic fields at the target spatial locations and desired mode profiles for the predetermined wavelength bands or polarization states;
performing, using the processor, an adjoint-based optimization of the refractive index distribution within the three-dimensional design volume, wherein the optimization utilizes electromagnetic simulations employing a Gaussian beam profile corresponding to the predetermined divergence angle as the incident electromagnetic radiation at the predetermined oblique angle, the optimization iteratively updating the refractive index distribution to optimize the figure of merit function while adhering to one or more predetermined fabrication constraints applied via differentiable filters; and
outputting, using the processor, the optimized refractive index distribution defining the physical structure of the volumetric meta-optic device.

2. The method of claim 1, wherein formulating the figure of merit function further comprises including a term configured to minimize electromagnetic field intensity or mode overlap in spatial locations on the target plane adjacent to the distinct target spatial locations.

3. The method of claim 1, wherein performing the adjoint-based optimization further comprises modeling one or more physical barrier regions adjacent to or within the three-dimensional design volume during the electromagnetic simulations.

4. The method of claim 3, wherein performing the adjoint-based optimization further comprises setting a sensitivity of the figure of merit function to zero within the modeled physical barrier regions when updating the refractive index distribution.

5. The method of claim 1, wherein the predetermined fabrication constraints include applying a differentiable binarization filter based on a hyperbolic tangent function to enforce a substantially binary refractive index distribution corresponding to two distinct material indices.

6. The method of claim 1, wherein the predetermined fabrication constraints include applying one or more differentiable filters selected from the group consisting of: a minimum feature size filter using erosion and dilation operations, and a border constraint filter fixing the refractive index in a predefined border region.

7. The method of claim 1, wherein updating the refractive index distribution utilizes an adaptive moment estimation.

8. The method of claim 1, further comprising fabricating the volumetric meta-optic structure according to the optimized refractive index distribution, wherein the structure comprises multiple layers of patterned materials.

9. The method of claim 1, further comprising repeating the method for a plurality of different predetermined oblique angles of incidence to generate a corresponding plurality of different optimized refractive index distributions, each defining a structurally distinct volumetric meta-optic device optimized for a specific angular zone within an array.

10. A method for fabricating a volumetric meta-optic structure configured for sorting electromagnetic radiation incident at a predetermined oblique angle, the method comprising:
obtaining an optimized three-dimensional refractive index profile defining a multi-layer arrangement of at least two dielectric materials in a non-periodic pattern having sub-wavelength features, wherein the optimized refractive index profile is determined by an adjoint-based optimization process utilizing electromagnetic simulations employing a Gaussian beam profile incident at the predetermined oblique angle; and
fabricating the multi-layer, three-dimensional structure according to the optimized refractive index profile by sequentially forming a plurality of layers, wherein forming each layer comprises arranging the at least two dielectric materials according to the non-periodic pattern specified by the optimized refractive index profile for that layer.

11. A volumetric meta-optic device for sorting electromagnetic radiation incident at a predetermined oblique angle from a source having a predetermined divergence angle, the device comprising:
a multi-layer, three-dimensional structure comprising at least two dielectric materials arranged in a non-periodic pattern within a volume according to an optimized refractive index profile, the pattern having sub-wavelength features;
wherein the optimized refractive index profile is determined by an adjoint-based optimization process utilizing electromagnetic simulations employing a Gaussian beam profile corresponding to the predetermined divergence angle incident at the predetermined oblique angle, and optimizing a figure of merit function based at least in part on a mode overlap calculation; and
wherein the arrangement of the at least two dielectric materials within the multi-layer, three-dimensional structure is configured to cause multiple scattering of incident electromagnetic radiation to direct different predetermined wavelength bands or polarization states thereof to distinct target spatial locations on an output plane adjacent to the device.

12. The device of claim 11, wherein the optimized refractive index profile is further determined by optimizing a figure of merit function that includes minimizing electromagnetic field intensity or mode overlap in spatial locations on the output plane adjacent to the distinct target spatial locations, wherein the arrangement of the at least two dielectric materials is further configured to reduce scattering into said adjacent spatial locations.

13. The device of claim 11, further comprising one or more integrated physical barrier structures adjacent to or integrated within the multi-layer, three-dimensional structure, the physical barrier structures configured to reduce optical crosstalk between the distinct target spatial locations or adjacent devices.

14. The device of claim 13, wherein the physical barrier structures comprise trenches filled with a material having a different refractive index than the at least two dielectric materials forming the non-periodic pattern.

15. The device of claim 11, wherein the optimized refractive index profile is substantially binary, such that the multi-layer, three-dimensional structure consists essentially of regions of a first dielectric material and regions of a second dielectric material, the regions forming the non-periodic pattern.

16. The device of claim 15, wherein the first dielectric material comprises Titanium Dioxide (TiO2) and the second dielectric material comprises Silicon Dioxide (SiO2).

17. The device of claim 11, wherein the predetermined oblique angle is greater than 5 degrees relative to a normal to a surface of the device structure.

18. The device of claim 11, wherein the multi-layer, three-dimensional structure comprises features defined by fabrication constraints applied during the optimization process, the features selected from the group consisting of: a minimum feature size limit, and a constrained border region having a fixed material composition.

19. An image sensor comprising:
an array of pixels; and
a corresponding array of volumetric meta-optic devices according to claim 11 positioned relative to the array of pixels such that the output plane of each device corresponds to at least one pixel.

20. The image sensor of claim 19, wherein the array of volumetric meta-optic devices comprises at least two structurally distinct volumetric meta-optic devices, a first device optimized for a first predetermined oblique angle and positioned in a first region of the array, and a second device optimized for a second, different predetermined oblique angle and positioned in a second region of the array.
